(19) United States
(12) Patent Application Publication
(10) Pub. No.: US 2009/0045227 A1
(43) Pub. Date: Feb. 19, 2009

(54) EXTENDABLE APPLICATOR FOR FLOWABLE MATERIALS

(76) Inventor: Shay ABUDI, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/839,593

(22) Filed: Aug. 16, 2007

(51) Int. Cl. B67D 5/64

(52) U.S. Cl. 222/174; 222/326; 222/327

(57) ABSTRACT

A flowable materials applicator that solves the problem of applying flowable materials to places that are located beyond the reach of the construction worker. The applicator comprises a handle which comprises the standard mechanism of standard flowable materials applicators. The handle further comprises means for mounting a housing. The housing, in turn comprises means for mounting to the handle on one end and means for mounting to another housing on the other end. Further housings may be available for mounting on the first housing. Thus by concatenating several housings, the required length is achieved. Then, rods are mounted similarly, one after another from the handle to the last housing, wherein the last rod is attached to a disc so that a standalone working applicator is mounted and ready for use.

### FIELD OF THE INVENTION

The present invention relates generally to construction tools and more specifically to flowable materials applicators.

### BACKGROUND OF THE INVENTION

Flowable materials are often used by construction workers for filling, sealing, insulating and the like. For relatively small works, where only a small amount of material is required a tube filled with the material usually suffices. For most other works, the standard applicator is used. The standard applicator shown in FIG. 1 often comprises a semi cylindered housing 150 that may accommodate an ampoule filed with the flowable material. The housing is affixed to a handle 110 enabling a comfort and stable holding by a user. The handle usually comprises a lever 120 attached to a compression spring 130 and to a first end of a rod 140, wherein a piston 160 is attached to the second end of the rod.

Upon operation, the user presses the lever that in turn pushes the rod 140 and the piston 160 which imposes pressure upon the back side of the ampoule filled with the flowable material. The back end is pressed into the ampoule and as a result, the flowable material flows out of a nozzle, at the other side of the applicator, thus enabling a simple and steady application of the flowable material.

The problem with the standard applicator derives from its limited length. Presently, standard flowable material applicators arc adjusted to accommodate a standard flowable material ampoule, which is approximately 60 cm in length. This imposes limitations on the abilities of construction workers to apply filling, sealable material and the like when conducting a construction job. Sometimes a construction worker has to risk himself while climbing up or down in order to get to a crack or a hole that needs to be filled or sealed. In other occasion, the required job is not performed altogether due to the afore-mentioned risks.

### SUMMARY OF THE INVENTION

The present invention discloses an extendable flowable materials applicator that solves the afore-mentioned problem of applying flowable materials to places that are located beyond the reach of the construction worker. The applicator comprises a handle which comprises the standard mechanism of standard flowable materials applicator or any mechanism that may be available in the future. The handle further comprises means for mounting a housing. The housing, in turn comprises means for mounting to the handle on one end and means for mounting to yet another housing on the other end. Further housings may be available for mounting on each other. Thus, by concatenating several housings, the required length is achieved. Then, rods are mounted similarly, one after another from the handle to the last housing, wherein the last rod is attached to a piston so that a standalone working applicator is mounted and ready for use.

In embodiments, the handle is affixed to the first housing. In other embodiments it is mountable to several housing and a smaller-than-standard housing (e.g, 30 cm) may be mountable thus allowing smaller ampoule to be accommodated in the housing. This may serve in construction jobs where the working space is limited.

In embodiments, the mounting means may be a bolt lock wherein the second housing is slide out from the first housing outward until the bolt lock locks the second housing. The bolt lock is a set of two pins affixed to one end of the first housing wherein corresponding holes are carved in the other end of the second housing and wherein the pins may enter into the housing when the other housing slides over them and enter to the holes when the holes appear above them. The rods are concatenated one after another from the handle to the piston inclusive. Concatenation may be achieved by screwing on rod into another of by male-female connector or any other connector.

In embodiments, the mounting means are a hinged mechanism attaching together the first housing and the second housing. The hinged mechanism further comprises a hinged lock that is applied after the second housing is straightened to align in one line with the first housing. The rods are the mounted in a similar way as explained above.

In embodiments, the mounting means comprises a set of pins on one end of the first housing and a set of holed on the corresponding (adjoined) end of the second housing. Upon installation, the two housings are attached and the pins are aligned into the holes. The holes are shaped so that a small rotation locks the pins in the holes. The rods are the mounted in a similar way as explained above.

### BRIEF DESCRIPTION OF DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a schematic illustration of a standard applicator according to the prior art;

FIG. 2 is a schematic illustration showing an embodiment of the present invention;

FIG. 3 is a schematic illustration showing the extendable applicator according to some embodiments of the present invention;

FIG. 4 is a schematic illustration showing an embodiment of the present invention;

FIG. 5 is a schematic illustration showing an embodiment of the present invention;

FIG. 6 is a schematic illustration showing an embodiment of the present invention;

FIG. 7 is a schematic illustration showing an embodiment of the present invention; and

FIG. 8A and 5B are schematic illustrations showing an embodiment of the present invention.

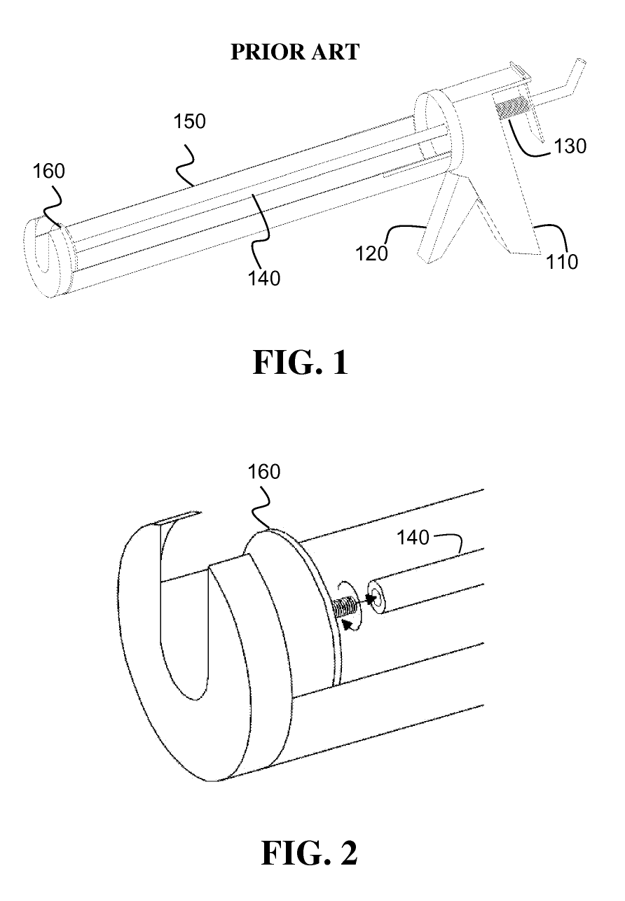

The drawings together with the description make apparent to those skilled in the art how the invention may be embodied in practice.

Further, where considered appropriate, reference numerals may be repeated among the figures to indicate corresponding or analogous elements.

### DETAILED DESCRIPTION OF THE INVENTION

The present invention discloses a flowable materials applicator that solves the problem of applying flowable materials to places that are located beyond the reach of the construction worker. The applicator comprises a handle which comprises the standard mechanism of standard flowable materials applicators. As opposed to standard applicator the handle further comprises means for mounting a housing. The housing, in turn comprises means for mounting to the handle on one end and means for mounting to another housing on the other end. Further housings may be available for mounting on the first housing. Thus by concatenating several housings, the required length is achieved. Then, rods are mounted similarly, one after another from the handle to the last housing, wherein the last rod is attached to a disc so that a standalone working applicator is mounted and ready for use.

FIG. 2 shows a feature of the extendable applicator according to some embodiments of the invention. The piston 160 may be screwed out of the rod 140 thus enabling the mounting of an extra rod and an extra housing thereon. Clearly, more housing may be concatenated in a telescopic manner to further extend the range of the applicator.

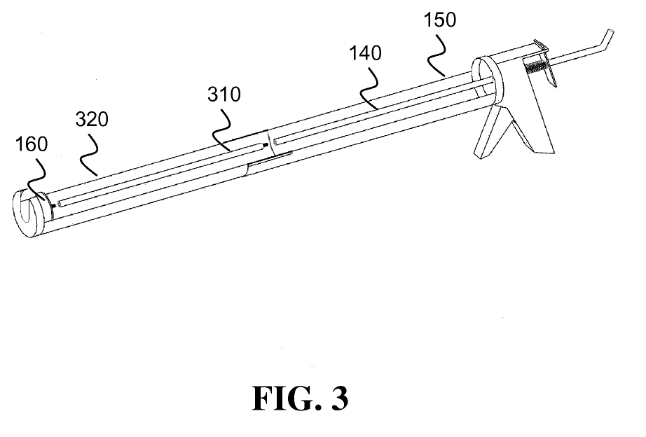

FIG. 3 shows the extendable applicator according to some embodiments of the invention. The piston 160 may be screwed in to an extra 310 and en extra housing 320 is connected to the basic hosing 150. The piston 160 may be thus connected via rod 140 thus enabling the concatenating of an extra rod and an extra housing thereon.

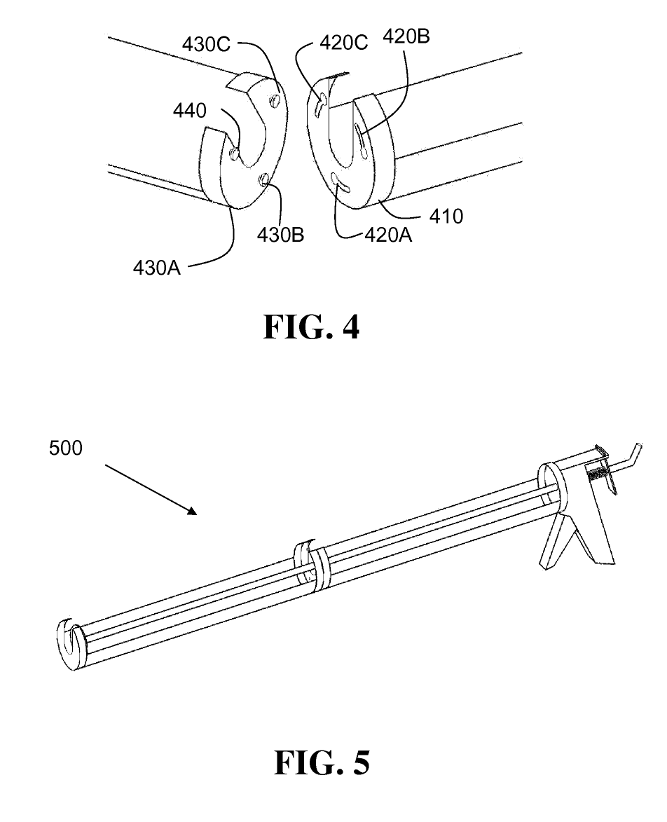

FIG. 4 shows a feature of the extendable applicator according to some embodiments of the invention. The figure shows how the extra housing may be mounted on top of the original housing. It should be understood that many approaches for mounting the two housing exist. The solution according to some embodiments is that pills and holes are used to mount the extra (second) housing on top present (first) one Specifically, each housing comprises a mounting surface, 410 and 440 respectively. Mounting surface 440 comprises bolts 430A, 430B and 430C. The bolts fit the corresponding holes 420A, 420B and 420C in Mounting surface 410 comprises piston 160 may be screwed out of the rod 140 thus enabling the mounting of an extra rod and an extra housing thereon.

FIG. 5 shows the extendable applicator according to some embodiments of the invention. The whole applicator 500 is shown in an extended position, after the means for mounting the housing wherein the mounting is performed by the bolts and the corresponding holes.

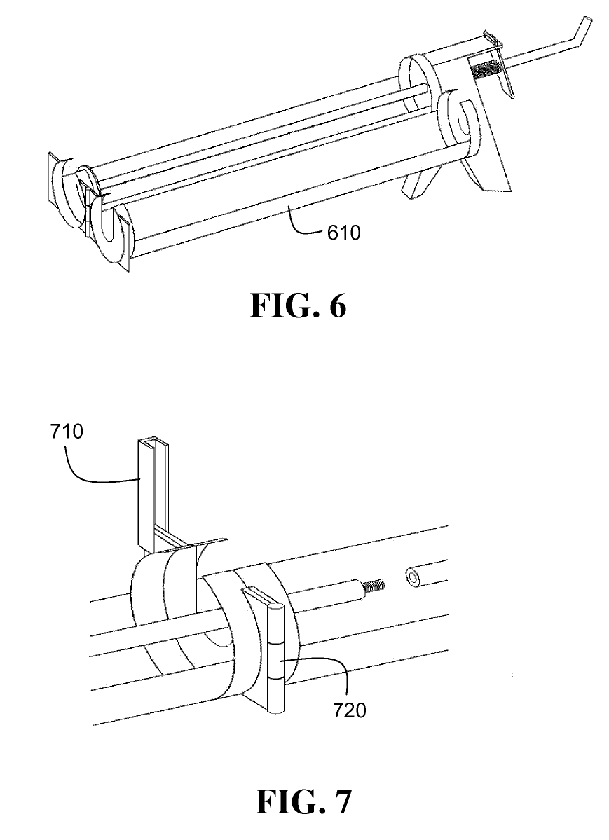

According to some embodiments of the invention, the mounting means are a hinged mechanism attaching together the first housing and the second housing The hinged mechanism further comprises a hinged lock that is applied after the second housing is straightened to align in one line with the first housing. The rods are the mounted in a similar way as explained above. FIG. 6 shows how the extra housing 610 may be hingedly mounted on top of the original housing. Upon mounting the extra housing,

FIG. 7 shows close-up of the extending mechanism of the applicator according to some embodiments of the invention. The hinge 720 connects the extra housing to the existing housing. A stop 710 is also provided for securing the extra housing to the existing housing.

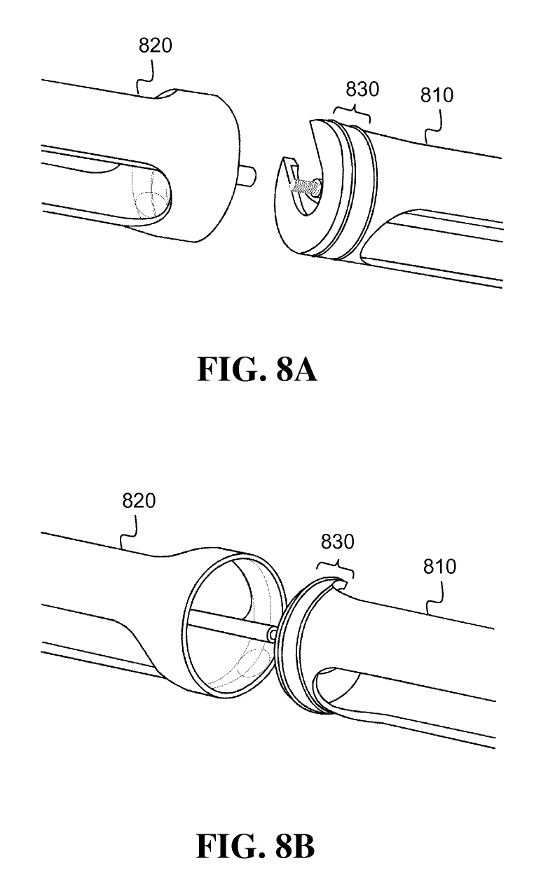

FIG. 8A and 8B shows an embodiment of the present invention. Specifically, it shows a first housing 810 and a second housing 820 wherein the means for mounting the second housing upon the first housing are in the form of an outer thread 830 at the end of the first housing 810 and an inner thread at the end of the second housing 820.

According to some embodiments of the invention, the handle is affixed to the first housing. In other embodiments it is mountable to several housing and a smaller-than-standard housing (e.g, 30 cm) may be mountable thus allowing smaller ampoule to be accommodated in the housing. This may serve in construction jobs where the working space is limited.

According to some embodiments of the invention, the mounting means may be a bolt lock wherein the second housing is slide out from the first housing outward until the bolt lock locks the second housing. The bolt lock is a set of two pins affixed to one end of the first housing wherein corresponding holes are carved in the other end of the second housing and wherein the pins may enter into the housing when the other housing slides over them and enter to the holes when the holes appear above them. The rods are concatenated one after another from the handle to the piston inclusive. Concatenation may be achieved by screwing on a rod into another of by male-female connector or any other connector.

According to some embodiments of the invention, the mounting means comprises a set of pins on one end of the first housing and a set of holed on the corresponding (adjoined) end of the second housing. Upon installation, the two housings are attached and the pins are aligned into the holes. The holes are shaped so that a small rotation locks the pins in the holes. The rods are mounted in a similar way as explained above.

According to some embodiments of the invention, the ampoule is reusable and may be supplied with the applicator in a form of a kit, the reusable ampoule may be used for non-conventional flowable materials such as cement that is prepared ad hoc for specific use with the applicator.

It should be noted that the flowable materials may be from a variety of materials, such as sealable materials, insulating materials, polymerized silicone, water based cement, flowable polymers, adhesive materials and the like.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarity all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein in addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. An extendable flowable materials applicator, said applicator comprising:
a handle comprising a mechanism for applying flowable materials from a flowable material ampoule;
a first housing connected to said handle, said first housing comprising means for mounting a second housing;
a second housing comprising means for mounting upon said first housing;
means for connecting the a mechanism for applying flowable materials to the end of the flowable material ampoule through the housings;
wherein mounting the second housing upon the first housing extends the range of applying flowable materials.

2. The applicator of claim 1, wherein the mechanism for applying flowable materials form a flowable material ampoule comprises a lever connected through a compression spring to a rod, wherein the rod is connected to a piston the presses one end of the ampoule whereby the flowable material flows through a nozzle on the other side of the ampoule.

3. The applicator of claim 1, wherein the handle is connected to the first housing via means for mounting the first housing.

4. The applicator of claim 1, wherein the means for mounting the second housing comprise a hinge and a stopper.

5. The applicator of claim 1, wherein the means for mounting the second housing comprise a plurality of pins affixed to a first mounting surface connected to one housing and a plurality of corresponding holes on a second mounting surface connected to the other housing.

6. The applicator of claim 1, wherein the means for mounting the second housing comprise a plurality of magnet pieces on one end of the first housing configured to attract a plurality of magnet pieces on the corresponding end of the second housing.

7. The applicator of claim 1, wherein the means for mounting the second housing comprises a threaded first housing and a correspondingly threaded second housing.

8. The applicator of claim 1, wherein the second housing is configured to slide outwards from the first housing and lock whereby the second housing is fully exposed.

9. The applicator of claim 1, wherein the first housing is smaller than standard flowable material ampoule.

10. The applicator of claim 1, wherein a third housing is mountable upon the second housing.

11. The applicator of claim 1, wherein pluralities of housings are concatenated one to another and mounted to the second housing.

12. The applicator of claim 1, wherein the flowable material is at least one of the following: sealable material, insulating material, polymerized silicone, water based cement, flowable polymer, adhesive material.

13. The applicator of claim 1, wherein the ampoule is reusable.

14. The applicator of claim 1, wherein the means for mounting a second housing is a thread.
